(19) United States
(12) Patent Application Publication
(10) Pub. No.: US 2005/0181138 A1
(43) Pub. Date: Aug. 18, 2005

(54) Method of treating the surface of a brazed evaporator

(76) Inventor: Christian Casenave, La Suze Sur Sarthe (FR)

Correspondence Address: Ronald Courtney;Valeo Inc, Intellectual Property Department, 4100 North Atlantic Boulevard, Auburn Hills, MI, 48326, US

(21) Appl. No.: 10/507,456

(22) PCT Filed: Mar. 13, 2003
(86) PCT No.: PCT/FR03/00809

(51) Int. Cl. B05D 7/00

(52) U.S. Cl. 427/402

(57) ABSTRACT

The surface of the evaporator is treated, without a preliminary stage of surface conversion, with a liquid comprising one or more substances capable of conferring, on the resulting coat, properties of adherence to the substrate and film-forming and corrosion-inhibiting and hydrophilic properties and one or more substances capable of conferring, on said coat, antimicrobial properties, the ratio by weight of the substances capable of conferring adherence properties and film-forming, corrosion-inhibiting and hydrophilic properties to the substances capable of conferring antimicrobial properties being less than or equal to 2/100. The coat thus formed is insoluble in water and does not exhibit an odor. Application to air conditioners for vehicles.

The invention relates to a process for the surface treatment of an evaporator brazed with aluminum or aluminum alloy, in particular for a liquid coolant circuit in an air conditioner for the passenger compartment of a vehicle.

In vehicle air conditioners, an evaporator is swept with a stream of air to be cooled. Because of the low temperature of the surfaces of the evaporator exposed to the stream of air, the moisture present in the latter tends to be deposited on these surfaces and this results in several disadvantages. The water thus deposited reduces the cross section for passage of the air and prevents direct contact between the latter and the metal surfaces of the evaporator, harming the heat exchange capability. Drops of water are thrown off into the stream of air. Stains adhere to the wetted surfaces, promoting microbial growth and the production of unpleasant odors.

To overcome these disadvantages, U.S. Pat. No. 5,538,078 A in particular discloses a process in which the surfaces of the evaporator which are intended to come into contact with a medium to be cooled are covered with a treatment liquid and said liquid is dried, the latter comprising substances capable of forming after drying on said surfaces an adherent coat having film-forming, hydrophilic and antimicrobial properties.

In this known process, the stage consisting in covering the surfaces with treatment liquid is preceded by a preliminary stage of surface conversion intended to make possible good attachment of the film-forming, hydrophilic and antimicrobial coat. The conversion can be carried out using hexavalent chromium salts or zirconium or titanium compounds or can be a phosphatization.

While this conversion stage had always been regarded as essential, it has been found, surprisingly, that an appropriate dosage of the constituents of the treatment liquid makes it possible to obtain good adhesion of the final coat without having recourse at this stage.

The invention is targeted in particular at a process of the type defined in the introduction and provides for said substances to comprise one or more substances capable of conferring, on said coat, properties of adherence to the substrate and film-forming, corrosion-inhibiting and hydrophilic properties and one or more substances capable of conferring, on said coat, antimicrobial properties, the ratio by weight of the substances capable of conferring adherence properties and film-forming, corrosion-inhibiting and hydrophilic properties to the substances capable of conferring antimicrobial properties being less than or equal to 2/100, and for said surfaces to be covered with the treatment liquid without a preliminary stage of surface conversion.

Optional characteristics of the invention, which are complementary or by way of substitution, are set out below:
Said surfaces are covered with the treatment liquid without a preliminary stage of degreasing or stripping said surfaces.
The ratio by weight of the substances capable of conferring adherence properties and film-forming, corrosion-inhibiting and hydrophilic properties to the substances capable of conferring antimicrobial properties is between 0.1/100 and 2/100.
Said substances do not exhibit a characteristic odor.
Said substances comprise, as substances capable of conferring, on said coat, properties of adherence to the substrate, one or more polymers chosen from the polyurethane, epoxy, silicone, acrylic, polyimine, polyamine and polyurea types.
Said substances comprise one or more substances capable of conferring, on said coat, at the same time, film-forming and corrosion-inhibiting properties and hydrophilic properties.
Said substances capable of conferring, at the same time, film-forming and corrosion-inhibiting properties and hydrophilic properties are polymers chosen from the polyurethane, epoxy, silicone, acrylic, polyimine, polyamine and polyurea types which are partially crosslinked so as to allow hydrophilic groups, such as carboxyl, hydroxyl, amine, imine, ketone and aldehyde groups, to remain.
Said substances comprise one or more substances capable of conferring, on said coat, film-forming and corrosion-inhibiting properties and one or more substances capable of conferring, on said coat, hydrophilic properties, the ratio by weight of the substances capable of conferring film-forming and corrosion-inhibiting properties to the substances capable of conferring hydrophilic properties being between 20/100 and 50/100.
Said substances capable of conferring film-forming and corrosion-inhibiting properties are polymers chosen from the polyurethane, epoxy, silicone, acrylic, polyimine, polyamine and polyurea types which are crosslinked so as to allow virtually no hydrophilic group to remain and said substances capable of conferring hydrophilic properties are chosen from silica, silica modified by the bonding of organic radicals to silicon atoms, titanium oxide and the hydrophilic varieties of zeolites.
Said substances capable of conferring antimicrobial properties are organic or organometallic compounds chosen from copper salts, zinc salts, 2-(n-octyl)isothiazolin-3-one, zinc pyridinethione, thiabendazole and methyl 2-benzimidazolecarbamate.

Another subject matter of the invention is an evaporator brazed with aluminum or aluminum alloy, in particular for a liquid coolant circuit in an air conditioner for the passenger compartment of a vehicle, for example obtained by the process as defined above, in which the surfaces intended to come into contact with a medium to be cooled are coated with an adherent coat comprising one or more substances conferring, on said coat, properties of adherence to the substrate and film-forming, corrosion-inhibiting and hydrophilic properties and one or more substances conferring, on said coat, antimicrobial properties, the ratio by weight of the substances conferring adherence properties and film-forming, corrosion-inhibiting and hydrophilic properties to the substances conferring antimicrobial properties being less than or equal to 2/100, and said surfaces being devoid of any undercoat for surface conversion.

The evaporator according to the invention can comprise at least some of the following distinctive features:
Said substances are as defined above.
The thickness of said coat is between 0.1 and 5 μm.
Said coat is capable of limiting the phenomena of adsorption and of desorption, so as to prevent the formation of odors.
Said coat is insoluble in water.

When the treatment liquid comprises polymers of the polyurethane, epoxy, silicone, acrylic, polyimine, polyamine and polyurea type, the latter can confer, on the resulting coat, properties of adherence to the substrate and/or film-forming and/or hydrophilic properties, according to their degree of crosslinking. More specifically, noncrosslinked polymers contribute only adherence properties, partially crosslinked polymers contribute the three types of properties and completely crosslinked polymers contribute adherence properties and film-forming properties.

The process according to the invention can be applied without distinction to brazed evaporators in a controlled atmosphere and to brazed evaporators under vacuum.

The constituents of the treatment liquid can be employed in the usual way, that is to say in particular in the form of an aqueous solution, immersion being followed by draining and by drying in an oven.

The adherence of the coat obtained by the process according to the invention dispenses not only with the preliminary stage of surface conversion but also with any preliminary stage of degreasing or stripping, if the condition of the surfaces allows it.

1. A process for the surface treatment of an evaporator brazed with aluminum or aluminum alloy, in particular for a liquid coolant circuit in an air conditioner for the passenger compartment of a vehicle, in which the surfaces of the evaporator intended to come into contact with a medium to be cooled are covered with a treatment liquid and said liquid is dried, the latter comprising substances capable of forming after drying on said surfaces an adherent coat having film-forming, hydrophilic and antimicrobial properties, characterized in that said substances comprise one or more substances capable of conferring, on said coat, properties of adherence to the substrate and film-forming, corrosion-inhibiting and hydrophilic properties and one or more substances capable of conferring, on said coat, antimicrobial properties, the ratio by weight of the substances capable of conferring adherence properties and film-forming, corrosion-inhibiting and hydrophilic properties to the substances capable of conferring antimicrobial properties being less than or equal to 2/100, and in that said surfaces are covered with the treatment liquid without a preliminary stage of surface conversion.

2. The process as claimed in claim 1, in which said surfaces are covered with the treatment liquid without a preliminary stage of degreasing or stripping said surfaces.

3. The process as claimed in either of claims 1 and 2, in which the ratio by weight of the substances capable of conferring adherence properties and film-forming, corrosion-inhibiting and hydrophilic properties to the substances capable of conferring antimicrobial properties is between 0.1/100 and 2/100.

4. The process as claimed in one of the preceding claims, in which said substances do not exhibit a characteristic odor.

5. The process as claimed in one of the preceding claims, in which said substances comprise, as substances capable of conferring, on said coat, properties of adherence to the substrate, one or more polymers chosen from the polyurethane, epoxy, silicone, acrylic, polyimine, polyamine and polyurea types.

6. The process as claimed in one of the preceding claims, in which said substances comprise one or more substances capable of conferring, on said coat, at the same time, film-forming and corrosion-inhibiting properties and hydrophilic properties.

7. The process as claimed in claim 6, in which said substances capable of conferring, at the same time, film-forming and corrosion-inhibiting properties and hydrophilic properties are polymers chosen from the polyurethane, epoxy, silicone, acrylic, polyimine, polyamine and polyurea types which are partially crosslinked so as to allow hydrophilic groups, such as carboxyl, hydroxyl, amine, imine, ketone and aldehyde groups, to remain.

8. The process as claimed in one of claims 1 to 5, in which said substances comprise one or more substances capable of conferring, on said coat, film-forming and corrosion-inhibiting properties and one or more substances capable of conferring, on said coat, hydrophilic properties, the ratio by weight of the substances capable of conferring film-forming and corrosion-inhibiting properties to the substances capable of conferring hydrophilic properties being between 20/100 and 50/100.

9. The process as claimed in claim 8, in which said substances capable of conferring film-forming and corrosion-inhibiting properties are polymers chosen from the polyurethane, epoxy, silicone, acrylic, polyimine, polyamine and polyurea types which are crosslinked so as to allow virtually no hydrophilic group to remain and said substances capable of conferring hydrophilic properties are chosen from silica, silica modified by the bonding of organic radicals to silicon atoms, titanium oxide and the hydrophilic varieties of zeolites.

10. The process as claimed in one of the preceding claims, in which said substances capable of conferring antimicrobial properties are organic or organometallic compounds chosen from copper salts, zinc salts, 2-(n-octyl)isothiazolin-3-one, zinc pyridinethione, thiabendazole and methyl 2-benzimidazolecarbamate.

11. An evaporator brazed with aluminum or aluminum alloy, in particular for a liquid coolant circuit in an air conditioner for the passenger compartment of a vehicle, in which the surfaces intended to come into contact with a medium to be cooled are coated with an adherent coat comprising one or more substances conferring, on said coat, properties of adherence to the substrate and film-forming, corrosion-inhibiting and hydrophilic properties and one or more substances conferring, on said coat, antimicrobial properties, the ratio by weight of the substances conferring adherence properties and film-forming, corrosion-inhibiting and hydrophilic properties to the substances conferring antimicrobial properties being less than or equal to 2/100, and said surfaces being devoid of any undercoat for surface conversion.

12. The evaporator as claimed in claim 11, in which said substances are as defined in one of claims 3 to 10.

13. The evaporator as claimed in either of claims 11 and 12, in which the thickness of said coat is between 0.1 and 5 μm.

14. The evaporator as claimed in one of claims 11 to 13, in which said coat is capable of limiting the phenomena of adsorption and of desorption so as to prevent the formation of odors.

15. The evaporator as claimed in one of claims 11 to 14, in which said coat is insoluble in water.
